(19) United States
(12) Patent Application Publication
(10) Pub. No.: US 2013/0201388 A1
(43) Pub. Date: Aug. 8, 2013

(54) OPTICAL SENSING APPARATUS AND OPTICAL SETTING METHOD

(71) Applicant: Novatek Microelectronics Corp., Hsinchu (TW)

(72) Inventors: Po-Jen Hsiao, New Taipei City (TW); Shu-Fang Wang, Hsinchu City (TW)

(73) Assignee: NOVATEK MICROELECTRONICS CORP., Hsinchu (TW)

(21) Appl. No.: 13/647,405

(22) Filed: Oct. 9, 2012

Related U.S. Application Data
(60) Provisional application No. 61/595,001, filed on Feb. 3, 2012.

(30) Foreign Application Priority Data
Jun. 5, 2012 (TW) 101120150

(51) Int. Cl. H04N 5/225

(52) U.S. Cl. 348/360; 348/207.99; 348/E05.024

(57) ABSTRACT

An optical sensing apparatus includes an optical sensing pixel array and a plurality of micro-optical device sets. The optical sensing pixel array has a plurality of array elements, and each of the array elements has one or multiple of a plurality of optical sensing pixels. The micro-optical device sets are configured corresponding to the optical sensing pixels respectively. Each of the micro-optical device sets has a shifting vector with respect to one of the optical sensing pixels. The optical sensing pixel array has a reference original point. Two shifting vectors of two of the micro-optical device sets with respect to corresponding two of the optical sensing pixels at the same radial distance on two polar axes from the reference original point and along opposite directions are asymmetric.

### CROSS-REFERENCE TO RELATED APPLICATION

This application claims the priority benefits of U.S. provisional application Ser. No. 61/595,001, filed on Feb. 3, 2012 and Taiwan application serial no. 101120150, filed on Jun. 5, 2012. The entirety of each of the above-mentioned patent applications is hereby incorporated by reference herein and made a part of this specification.

### BACKGROUND

1. Technical Field

The present invention is related to an optical sensing apparatus and an optical setting method.

2. Background

In general, an optical sensing apparatus is used to at least sense an image externally. For example, an optical sensing unit of camera utilizes an optical device to capture the image to a valid range of the corresponding optical sensing apparatus.

The optical sensing apparatus generally includes an optical sensing pixel array, which is composed of a plurality of array elements, forming the valid range of the optical sensing area in a rectangular shape. Each of the array elements has one or multiple optical sensing pixels corresponding to different color components. The optical pixels of different color components form a pixel of an actual color.

FIG. 1 is a diagram illustrating the structure of a conventional optical sensing pixel array. Referring to FIG. 1, an optical sensing pixel array 100 has a reference origin 90, which is the intersection point of an X-axis 92 and a Y-axis 94 or the optical central point of the optical sensing pixel array. The optical sensing pixel array 100 has a plurality of array elements 102, which are distributed on an area in rectangular shape, for example, according to the resolution. Each of the array elements 102 has one or multiple optical sensing pixels, such as a plurality of optical sensing pixels 104 that correspond to different color components. For example, three optical sensing pixels 104 correspond to three different colors of red, green, and blue, respectively. However, the optical sensing pixels 104 of the array elements 102 are not limited to red, green, and blue ones.

For each of the optical pixels 104, in order to further focus incident light of image on the optical sensing device, a micro-lens (ML) is disposed thereon, corresponding to each of the optical pixels 104 to further focus light on the pixel.

One of the conventional configurations of the micro-lens 120 is to maintain the same configuration of the micro-lens 120 for each of the optical sensing pixels 104 in the optical sensing pixel array 100. When external incident rays are focused to the optical sensing pixel array 100 by an optical device, the incident angles of light in the central area and the edge area of the optical sensing pixel array 100 are different. Because the micro-lens 120 and optical sensing pixels 104 are disposed in the same way, a problem of non-uniformity in optical sensing occurs.

### SUMMARY

The exemplary embodiment of the present invention adjusts the position of a plurality of micro-optical devices with respect to the optical sensing pixel, which can at least reduce the phenomenon of non-uniformity in optical sensing.

An exemplary embodiment of the present invention provides an optical sensing apparatus. The optical sensing apparatus includes an optical sensing pixel array and a plurality of micro-optical device sets. The optical sensing pixel array has a plurality of array elements, and each of the array elements has one or multiple of a plurality of optical sensing pixels. The micro-optical device sets are configured corresponding to the optical sensing pixels respectively. Each of the micro-optical device sets has a shifting vector with respect to one of the optical sensing pixels. The optical sensing pixel array has a reference original point. Two shifting vectors of two of the micro-optical device sets with respect to corresponding two of the optical sensing pixels at the same radial distance on two polar axes from the reference original point and along opposite directions are asymmetric.

An exemplary embodiment of the present invention provides an optical setting method, adapted for an optical sensing pixel array. The optical sensing pixel array is composed of a plurality of array elements. Each of the array elements has one or multiple of a plurality of optical sensing pixels. A plurality of micro-optical device sets are respectively configured corresponding to the optical sensing pixels. The optical setting method includes setting a shifting vector for each of the micro-optical device sets with respect to corresponding one of the optical sensing pixels. Two shifting vectors are set to be asymmetric for two of the micro-optical device sets with respect to corresponding two of the optical sensing pixels at a same radial distance on two polar axes starting from a reference original point of the optical sensing pixel array and along opposite directions.

Another exemplary embodiment of the present invention provides an optical setting method. The optical setting method includes obtaining data of incident angles of light onto an optical sensing pixel array at different radial distances. Further, the method includes obtaining a plurality of reference shifting vectors of a plurality of micro-optical device sets corresponding to a plurality of reference optical sensing pixels in the optical sensing pixel array under a condition that a predetermined image quality is satisfied, according to the data of the incident angles of light and an actual structure of the optical sensing pixel array. Further, a plurality of shifting vectors of the micro-optical sets are obtained for the other optical sensing pixels in the optical sensing pixel array other than the reference optical sensing pixels according to respective positions of the other optical sensing pixels and positions of the reference optical sensing pixels, and the reference shifting vectors. .

In order to make the aforementioned and other features and advantages of the invention comprehensible, several exemplary implementations accompanied with figures are described in detail below.

### BRIEF DESCRIPTION OF THE DRAWINGS

The accompanying drawings are included to provide further understanding and are incorporated in and constitute a part of this specification. The drawings illustrate exemplary embodiments and, together with the description, serve to explain the principles of the disclosure.

FIG. 1 is a diagram illustrating the structure of a conventional optical sensing pixel array.

FIG. 2 is a diagram illustrating the disposition relationship between a plurality of micro-optical device sets and an optical sensing pixel array according to an exemplary embodiment.

FIG. 3A is a diagram illustrating the shifting mechanism of the disposition relationship between the micro-optical device sets and the optical sensing pixels according to an exemplary embodiment.

FIG. 3B is a diagram illustrating a principle of the generation of non-uniformity optical-sensing if in a case where a plurality of shifting vectors of the micro-optical device sets are arranged to be symmetric according to an exemplary embodiment.

FIG. 4 is a flow chart illustrating an optical setting method according to an exemplary embodiment of the present invention.

FIG. 5A is a diagram illustrating the relationship of the incident angle of light and the optical sensing pixels according to an exemplary embodiment, adapted to illustrate the incident angle of light of the optical sensing pixel array.

FIG. 5B is a diagram illustrating a characteristic function of the relationship between the incident angle of light θ of FIG. 5A and a radial distance.

FIG. 6 is a diagram illustrating the relative positions of the optical sensing device and the corresponding micro-optical device sets at different positions, and adapted to explain step S102 of FIG. 4.

FIG. 7 is a diagram illustrating a reference shifting vector of any of a plurality of reference optical sensing pixels, adapted to explain the simulation process of the reference shifting vector.

FIG. 8 is a diagram illustrating the response of a photodiode PD and a LSC gain with respect to the radial distance according to an exemplary embodiment of the present invention, adapted to illustrate how to determine the distribution of a predetermined PD response value.

FIG. 9 is a diagram illustrating the method of selecting a plurality of reference axes according to an exemplary embodiment of the present invention.

FIG. 10 is a diagram of the distribution of the reference optical sensing pixels according to an exemplary embodiment of the present invention.

FIG. 11 is a diagram of interpolation mechanism of the shifting vector according to an exemplary embodiment of the present embodiment.

FIG. 12 is a diagram illustrating the mechanism of the asymmetric shifting vectors according to an exemplary embodiment of the present invention.

FIG. 13 is a diagram illustrating the shifts of the micro-optical device sets according to an exemplary embodiment of the present invention.

FIG. 14 is a diagram illustrating the shifts of the micro-optical device sets according to an exemplary embodiment of the present invention.

FIG. 15 is a diagram illustrating the shifts of the micro-optical device sets according to an exemplary embodiment of the present invention.

FIG. 16 is a diagram illustrating the shifts of the micro-optical device sets according to an exemplary embodiment of the present invention.

FIG. 17 is a flow chart illustrating an optical setting method according to an exemplary embodiment of the present invention

FIG. 18 is flow chart illustrating an optical setting method according to an exemplary embodiment of the present invention.

### DETAIL DESCRIPTION OF DISCLOSED EMBODIMENTS

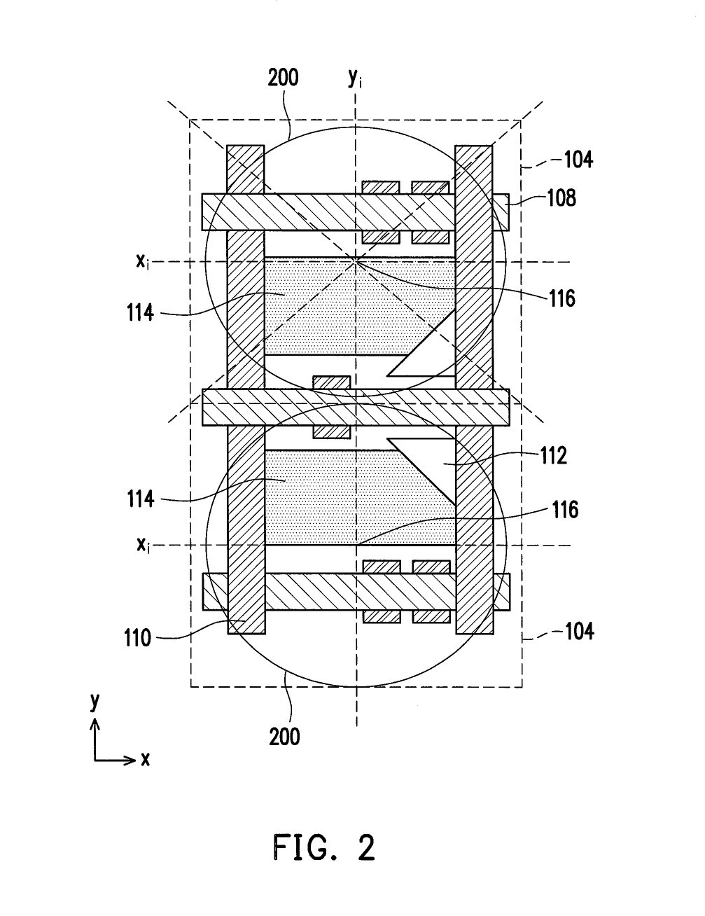

FIG. 2 is a diagram illustrating the disposition relationship between a plurality of micro-optical device sets and an optical sensing pixel array according to an exemplary embodiment, adapted to explain effect of optical sensing level of an optical sensing pixel due to the position of a micro-optical device.

Referring to FIG. 2, two adjacent optical sensing pixels 104 in an optical sensing pixel array 100 are illustrated, for example. Each of the optical sensing pixels 104 also has an xᵢ axis and a yᵢ axis, and each intersection point of the xᵢ axis and the yᵢ axis represents the position of an origin 116 of each of the optical sensing pixels 104.

For example, an optical sensing pixel 104 includes a polycrystalline device 106, a multilayer metal routing structure including a plurality of metal layers such as a first metal layer 108 (M1) and a second metal layer 110 (M2), a gate structure 112, and an optical sensing device 114 such as photodiodes (PD). Furthermore, the optical sensing pixels 104 are further configured with a plurality of micro-optical device sets 200 correspondingly to accept light corresponding to the optical sensing device 114. Each of the micro-optical device sets 200 includes one or multiple micro-optical devices. For example, each of the micro-sensing device sets 200 generally includes a micro-lens (ML), a color filter device, an optical diffraction device, any other type of the micro-optical devices that is able to guide or change the propagation direction of ray, or a combination of two or more devices mentioned above.

In the present exemplary embodiment, when the position of each of the micro-optical device sets 200 is adjusted, it is aligned with the position of the corresponding optical sensing pixel 104, in which the position refers to a position on the xy plane.

However, the relative positions of various devices in an optical sensing pixel 104 may not be identical between different optical sensing pixels 104. For example, for incident lights at different positions, different levels of shadowing effect are generated due to different incident angles. This would result in different optical sensing levels between the optical sensing devices of different pixels. The following further explains that with consideration of different incident angles of light at different positions on the optical sensing array 100, the micro-optical device sets 200 can be shifted appropriately with respect to the corresponding optical sensing pixels 104, thereby improving the optical-sensing uniformity of the optical sensing array 100 in the following exemplary embodiments.

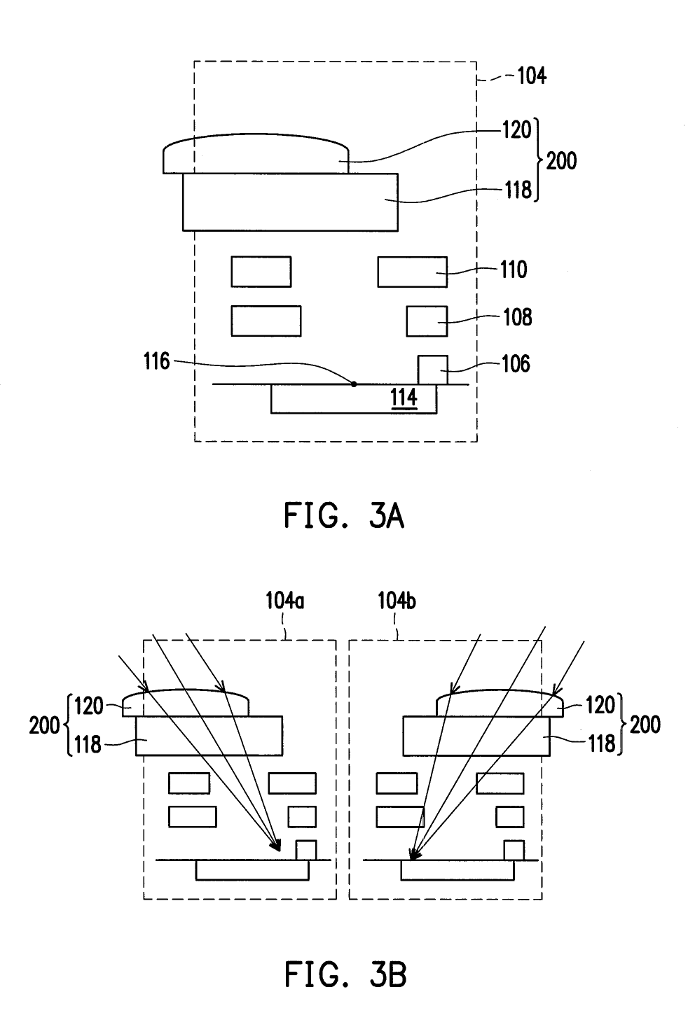

FIG. 3A is a diagram illustrating the shifting mechanism of the disposition relationship between the micro-optical device sets and the optical sensing pixels according to an exemplary embodiment. A micro-optical device set 200 includes one or multiple micro-optical devices, such as a micro-lens, a color filter device, an optical diffraction device, other device that is able to guide rays in the micro-optical devices, or a combination of at least the two devices mentioned above. In FIG. 3A, the micro-optical device set 200 includes a micro-lens 120 and a color filter device 118 as an example. However, the embodiment is not limited thereto. As shown in FIG. 3A, the micro-optical device set 200 has a shift in its position with respect to the position of the optical sensing pixel 104.

FIG. 3B is a diagram illustrating a principle of the generation of non-uniform optical-sensing in a case where a plurality of shifting vectors of the micro-optical device sets are arranged to be symmetric according to an exemplary embodiment. Referring to FIG. 3B, for two optical-sensing pixels 104a and 104b at the same radial distance on two polar axes along opposite directions, their cross sections of stacked layer structure appear to be identical. However, the optical-sensing pixels 104a and 104b are asymmetric with respect to a reference origin of the optical-sensing pixel array. Furthermore, the metal routings M1 and M2 may be different structures for the optical sensing pixels.

However, if merely an symmetric shifting, which means that the magnitude of the shifting vector is the same but the direction is reversed, that is done for two micro-optical device sets 200 at the same radial distance on two polar axes along opposite directions, the shadowing levels of the incident ray of the photodiode PD by the metal routings M1 and M2 will be different, for example. Thus, non-uniformity of the optical-sensing level occurs. In other words, since the actual structure of the optical sensing pixels 104 leads to different optical sensing levels for the optical sensing devices in the different pixels, if merely the symmetric shifting is done for the micro-optical device sets, that is, only the incident angle but not the actual structure is considered, the problem of non-uniformity optical sensing will still exist.

In the following exemplary embodiment, the actual structure of the optical sensing pixels and the incident angles of light at different positions are considered for appropriately shifting the micro-optical device sets 200 with respect to the optical sensing pixels 104 to improve the optical sensing uniformity of the optical sensing pixel array 100. More specifically, during the process of the appropriate shifting for the micro-optical device sets, a plurality of shifting vectors of the micro-optical device sets are obtained by simulating the incident angles of light at different positions under the actual structure of the optical sensing pixel array.

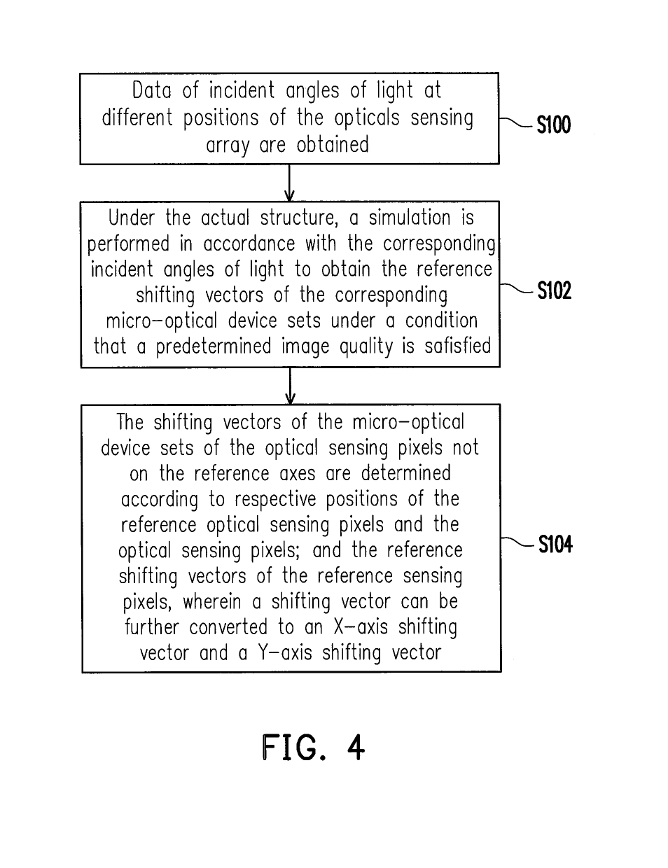

FIG. 4 is a flow chart illustrating an optical setting method according to an exemplary embodiment of the present invention. Referring to FIG. 4, in step S100, data of the incident angles of light at different positions of the optical sensing pixel array are obtained. The data indicates the relationship between the radial distance and the incident angle of light. In general, the data may be provided by a camera lens (also referred to as an imaging lens) vendor. In step S102, at least two reference axes of different polar angles are selected, and a plurality of reference optical sensing pixels with different radial distances are selected from the at least two reference axes. Next, under the actual structure, a simulation is performed for to the reference optical sensing pixels in accordance with the corresponding incident angles of light to obtain a plurality of reference shifting vectors of the corresponding micro-optical device sets under a condition that a predetermined image quality is satisfied. In step S104, for the other optical sensing pixels not on the reference axes, the shifting vectors of the micro-optical device sets of the other optical sensing pixels are determined according to the respective positions of the reference optical sensing pixels and the optical sensing pixels and the reference shifting vectors of the reference sensing pixels. While step S104 is performed, a shifting vector can be further converted to an X-axis shifting vector and a Y-axis shifting vector. The following further explains in detail for each step.

First, regarding step S100, when the micro-optical device sets 200 are to be shifted with respect to the corresponding optical sensing pixels 104, the data of the incident angles of light received by the micro-optical sensing sets 200 at different positions must be obtained first.

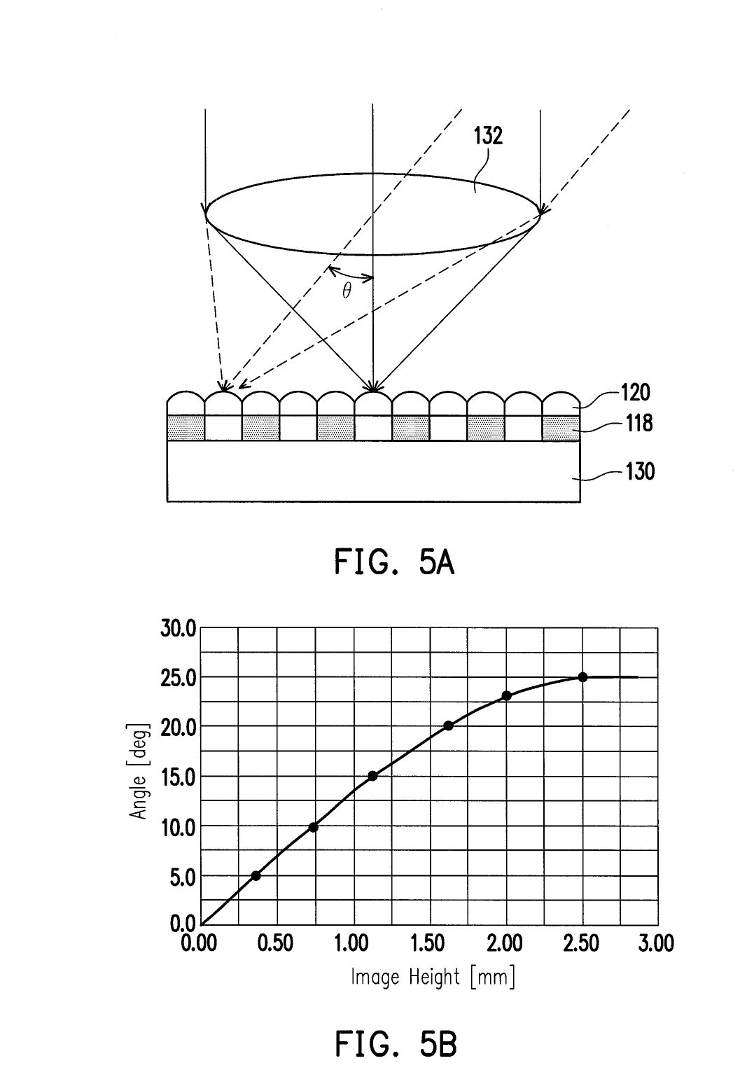

FIG. 5A is a diagram illustrating the relationship between the incident angle of light and the optical sensing pixels according to an exemplary embodiment, adapted to illustrate the incident angle of light of the optical sensing pixel array 100. Referring to

FIG. 5A, an imaging lens unit 132 is disposed over a circuit stacked layer 130, and a micro-lens 120 and a color filter device 118 are disposed corresponding to each of the optical sensing pixels, for example. After the imaging lens unit 132 receives image light, an image is formed on the circuit stacked layer 130 through the micro-lenses 120 and the color filter devices 118. As shown in FIG. 5A, the incident angle of light is represented by θ. Therefore, the data of the incident angle of light may be obtained by physical measurements with an apparatus such as shown in FIG. 5A. In general, the data of the incident angle of light may be obtained from camera lens vendors.

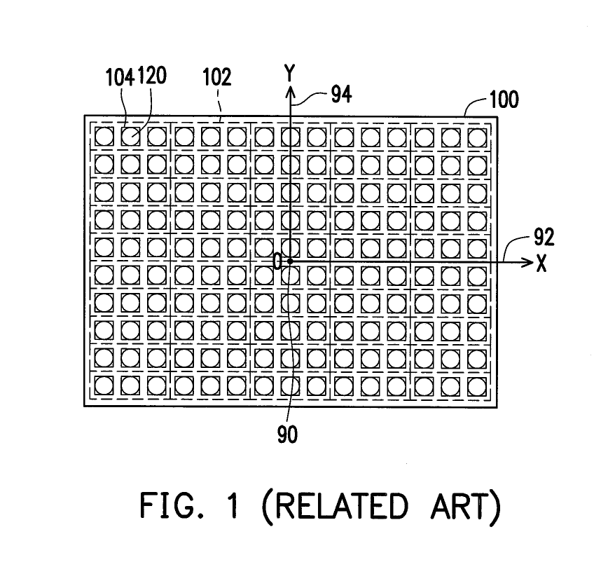

FIG. 5B is a diagram illustrating a characteristic function of the relationship between the incident angle of light θ of FIG. 5A and the radial distance. Referring to FIG. 5B, the horizontal axis represents image height (IH) parameter, which, also referred to as radial distance, represents the radial distance starting from a reference origin of an optical sensing array or an optical central point (e.g. a reference origin 90 in FIG. 1), and a larger value of image height represents a distance further away from the reference origin 90. The vertical axis represents the incident angle of light θ corresponding to image height. As shown in FIG. 5B, for the optical sensing pixel with the image height equal to zero, the incident angle of light θ is zero degree; when the image height is larger, the incident angle of light is larger as well. Generally, in step S100, the data of the characteristic function as shown in FIG. 5B can be obtained.

Referring back to FIG. 4, the process proceeds to step S102 next. At least two reference axes are selected corresponding to the different polar angles, and the reference optical sensing pixels of different image heights are selected on the at least two reference axes. Next, a simulation is performed for the reference optical sensing pixels according to the corresponding incident angles of light to obtain the reference shifting vectors of the micro-optical device sets under the condition that the predetermined image quality is satisfied.

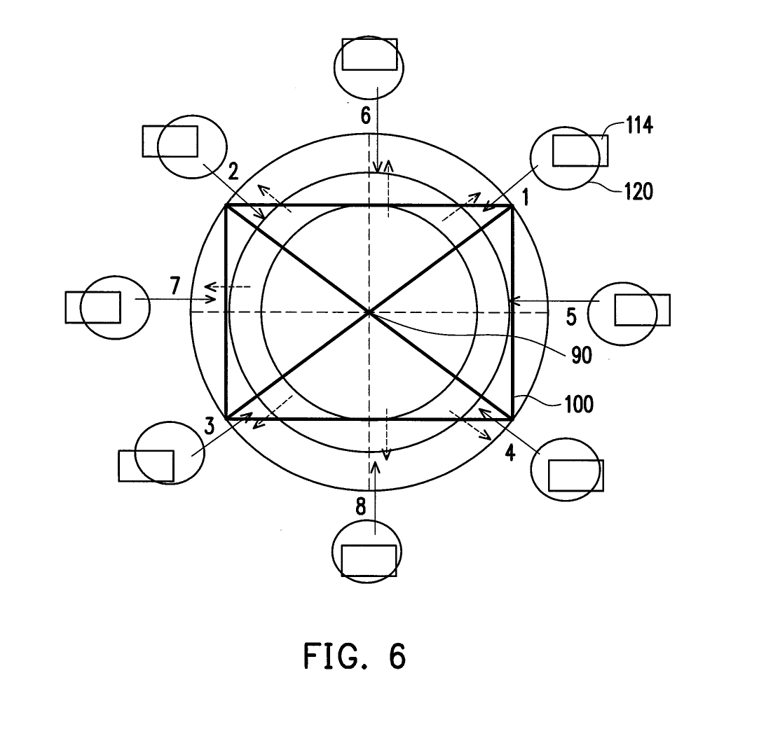

FIG. 6 is a diagram illustrating the relative positions of the optical sensing device and the corresponding micro-optical device set at different positions, and adapted to explain step S102 of FIG. 4. Referring to FIG. 6, the micro-optical device sets of the present exemplary embodiment are described with the positions of the micro-lenses 120 as an example for illustration. The optical sensing pixels 104 of the present exemplary embodiment are described with the optical sensing devices 114 as an example for illustration. However, the present exemplary embodiment is not limited thereto. In other words, the micro-optical device sets 200 are described with the micro-lenses 120 shifted with respect to the optical sensing device 114 as an example in the present exemplary embodiment. The amount required to shift the micro-optical device sets 200 with respect to the optical sensing pixels can be represented by a shifting vector. For the optical sensing pixel array 100, starting from the reference origin 90, a ring is formed and the optical-sensing pixels at different position on the ring have different polar angles.

First, the plurality of polar axes, e.g. 8 polar axes, are obtained and served as a plurality of reference axes, and a plurality of optical sensing pixels are selected on the reference axes as a plurality of reference optical sensing pixels. Next, a shifting vector of each of the micro-optical device sets 200 with respect to the corresponding reference optical pixel may be obtained as a reference shifting vector to determine a shifted position of the micro-optical device set 200. Because the shifting vector may be obtained through a simulation in accordance with the actual structure of the optical sensing pixels with the required incident angle of light, the shifting vector can be served as the reference shifting vector. A plurality of shifting directions of the micro-lenses 120 of the micro-optical device sets of the optical sensing pixels on the reference axes with respect to the optical sensing devices 114 are represented with a plurality of solid lines with arrows. Furthermore, each of a plurality of dotted lines with arrows represents the directions of the incident light.

In better detail, in adjusting the position of the micro-optical device set for each of the reference optical sensing pixels, a simulation can be performed according to the corresponding incident angle of light under the actual structure of the optical sensing pixel in which the corresponding incident angle of light is obtained by referring to the characteristic function shown in FIG. 5B in accordance with the image height of the location of the reference optical sensing pixel. During the simulation process, the appropriate reference shifting vectors of the micro-optical device sets of the reference optical sensing pixels can be obtained through adjusting the reference shifting vectors of the reference optical sensing pixels until the predetermined image quality condition is satisfied.

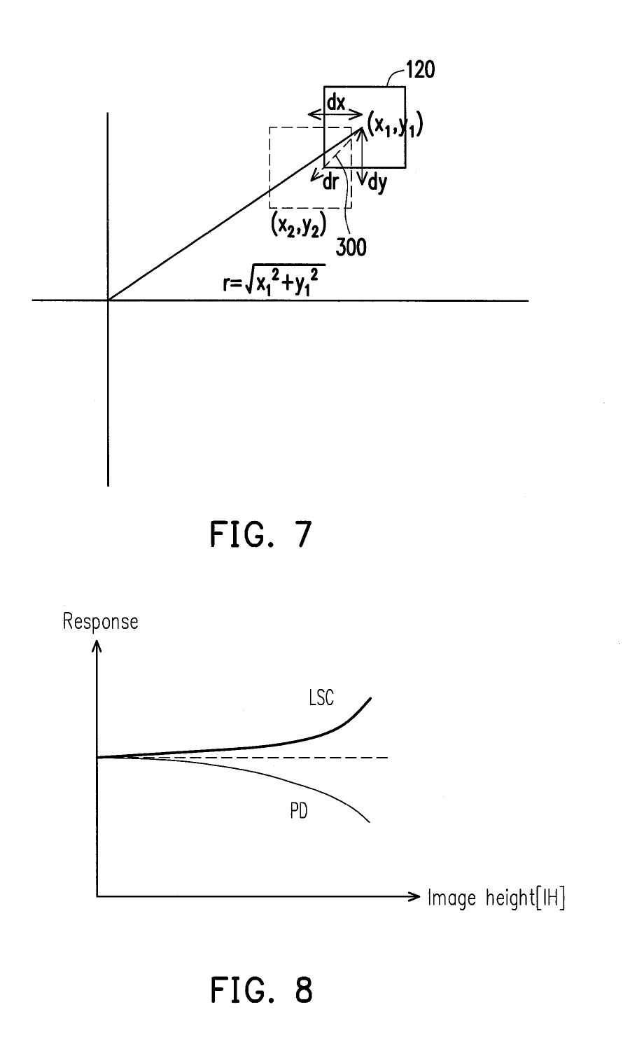

FIG. 7 is a diagram illustrating the reference shifting vector of any of the reference optical sensing pixels, adopted to explain the simulation process of the reference shifting vector. Referring to FIG. 7, for the optical sensing pixels 104 at a coordinate point (x1, y1), a reference shifting vector dr 300 of the micro-optical device set 200 may be decomposed to an x component dx and a y component dy. According to the shifting vector dr 300, the structural central point of the micro-optical device set 200 is shifted to a coordinate point (x2, y2) from (x1, y1). Wherein, the mathematic formulas (1) to (4) represent the relationship between the (x1, y1) and (x2, y2).

r=\sqrt{x₁²+y₁²}. (1)

dr=f(r)=aₙ·rⁿ+aₙ₋₁·rⁿ⁻¹+aₙ₋₁·rⁿ⁻²+ . . . +a₀. (2)

dx=dr·cos(θ)=dr·x/r. (3)

dy=dr·sin(θ)=dr·y/r. (4)

The geometry relationship of x/r is cos(θ), and y/r is sin(θ).

If eight reference axes and eight reference optical sensing pixels are used for example, the following formulas (5)-(7) are required for calculation:

dr₁=aₙ·rⁿ+aₙ₋₁·rⁿ⁻¹+aₙ₋₂·rⁿ⁻²+ . . . +a₀; (5)

dr₂=bₙ·rⁿ+bₙ₋₁·rⁿ⁻¹+bₙ₋₂·rⁿ⁻²+ . . . +b₀ . . . ; and (6)

dr₈=aₙ·rⁿ+hₙ₋₁·rⁿ⁻¹+hₙ₋₂·rⁿ⁻²+ . . . +a₀. (7)

In other words, the process of step S102, for example, includes simulating the points in accordance with the required incident angles of light, and obtaining the shifting vectors of the reference optical sensing pixels according to selected images under the predetermined image quality condition. Next, the final reference shifting vectors can be determined though a curve fitting, for example, and aₙ-a₀, bₙ-b₀, . . . , and hₙ-h₀ are determined at the same time accordingly. At the end, drᵢ can be decomposed into dxᵢ and dyᵢ (wherein, i=1-8) according to geometric relation.

The predetermined image quality condition that is to be attained in step S102 may, for example, include at least one of the following conditions: the difference between the responses of a GR optical sensing pixel and a GB optical sensing pixel in any area is not too large, such as within 3%, to avoid a maze-like pattern on the image. The difference between the responses of any of the optical sensing pixels at the same image height may not be too large to avoid an incapable calibration of a lens shading correction (LSC), which causes sectional color shading. The ratios R/G and B/G at any position on the entire image is preferred to be uniform to avoid sectional color shading as well. Furthermore, the predetermined quality condition may be designed according to the practical needs to sift out the appropriate reference shifting vectors in other exemplary embodiment.

It should be noted that the above image quality condition may include a PD response value. In other words, after the micro-optical devices are shifted appropriately, the PD response values of the optical sensing pixel array may reach a uniform distribution. Preferably, the PD response values may be arranged to have a distribution where the PD response values decay with the image height, and the shading trend is within the range of a LSC gain of a rear end image processing circuit.

FIG. 8 is a diagram illustrating the response of the photodiode PD and the LSC gain with respect to the image height (IH) according to an exemplary embodiment of the present invention, and adopted to illustrate how to determine the distribution of the predetermined PD response value.

Referring to FIG. 8, the shading response after the completion of simulation is often considered in an initial stage of design. Since the LSC gain is arranged to increase along with the rise of the radial distance, the greater the image height, the larger the LSC gain can be provided for a lower response of the photodiode. Furthermore, the PD response may be arranged to present a certain trend, which, for example, can be an attenuation of n^{th} order function, and (n can be between 2 to 4) within the range of the inverse of compensating LSC gain. In other words, a multiplication result of the LSC gain value and the PD response may be close to a horizontal dotted line, which leads to an uniform or color-shading free image because the response values at any image height after the adjustment tend to be equal. Therefore, in an exemplary embodiment, for the photodiodes at different image heights, the PD response values can be optimized in the design stage to complement with the LSC gain along each image height, which eventually improve the uniformity of image quality.

It should be noted that the number of the reference axes may be selected preferably according to the resolution requirements. In general, at least two reference axes are required for better accuracy of interpolating calculation. Take FIG. 6 as an example, a plurality of sectional areas can be configured based on the ranges of polar angles, so as to increase the accuracy of interpolation. For example, one given sensing array can be divided into 8 areas, while shifting vectors in each area can be determined by interpolating the shifting vectors of the two reference axes that are located at the boundary. However, the reference axes are not required to be arranged at the verge of the sensing area.

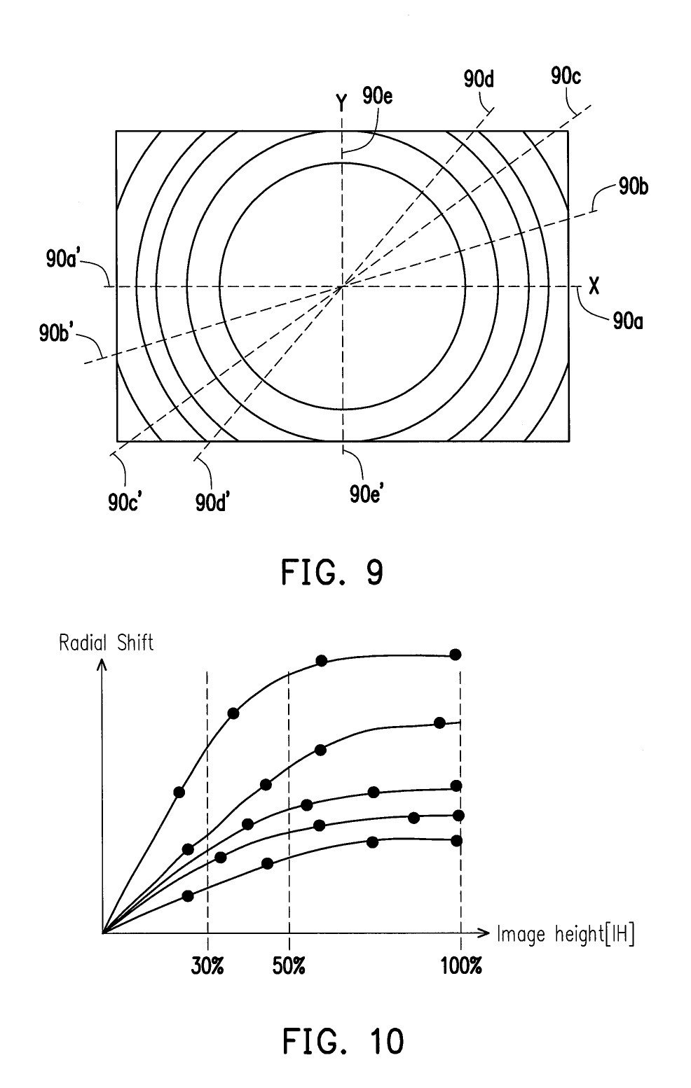

FIG. 9 is a diagram illustrating the method of selecting the reference axes according to an exemplary embodiment of the present invention. Referring to FIG. 9, based on consideration of the time consumed by simulation for example, the density of the selected reference axes is adjustable according to the practical needs, and the sampling interval does not have to be linear. For the selection of the reference axes 90a, 90b, 90c, 90d, 90e, 90′, 90b′, 90c′, 90d′, 90e′, the polar angles may be 0 degree, 90 degree, 180 degree, 270 degree, and angles to the corner points, or any other angles, without being limited to having any fixed angle spacing. The selection of the image height is similar without being limited to having a linear distribution.

FIG. 10 is a diagram of the distribution of the reference optical sensing pixels according to an exemplary embodiment of the present invention. Referring to FIG. 10, the horizontal axis indicates the image height, which is represented in percentage, and the vertical axis indicates the shifting vector. Each curve corresponds to a reference axis along a certain polar angle. A plurality of dots represent the reference optical sensing pixel undergoing the simulation, and each of the dots has a corresponding shifting vector. The sensing uniformity can be improved by making adjustment according to the shifting vectors obtained by the simulation.

Next, refer back to FIG. 4. In step S104, the shifting vectors of the micro-optical device sets 200 of other optical sensing pixels that are not located on the reference axes may be obtained according to the reference shifting vectors of the nearby reference optical sensing pixels. For example, the shifting vectors of the other optical sensing pixels that are not on the reference axes may be obtained by interpolating, based on the positions where they are located, including the image heights and polar angles with respect to the adjacent reference optical sensing pixels. The interpolation, for example, can be realized by an interpolation or extrapolation method calculated by an external simulation system. Other algorithms such as a curve fitting algorithm or other mathematic calculations capable of obtaining the shifting vectors of some positions according to the shifting vectors of other positions may also be utilized if required.

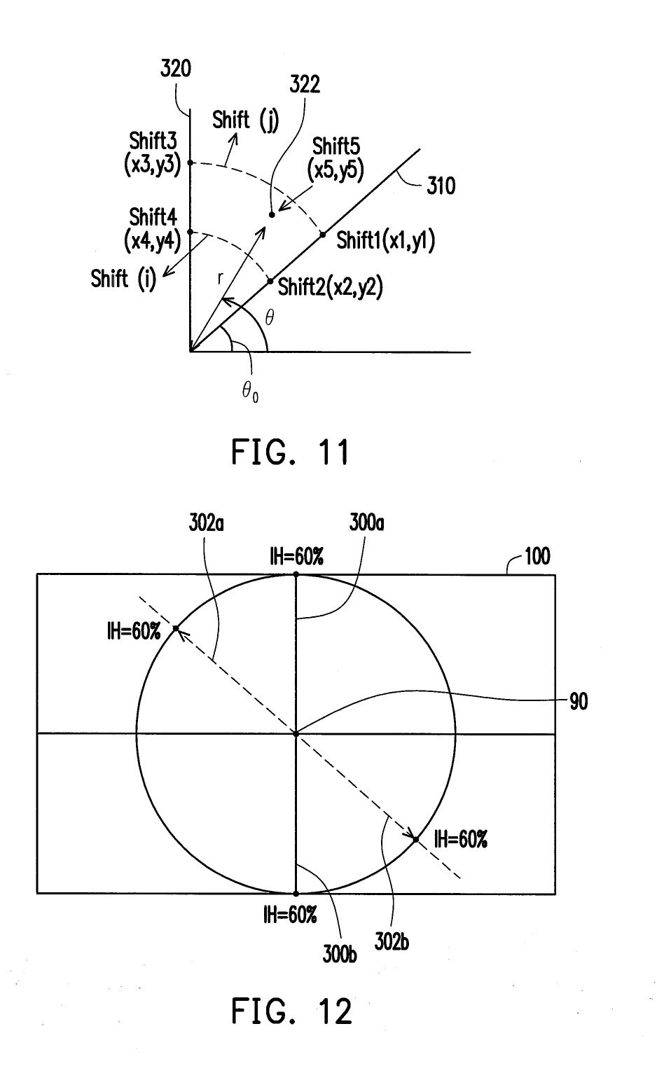

FIG. 11 is a diagram of interpolation mechanism of the shifting vector according to an exemplary embodiment of the present embodiment. Referring to FIG. 11, for example, two reference axes 310 and 320 are selected which are extended from the reference origin (x0, y0). There are a plurality of reference optical sensing pixels on the reference axes 310 and 320 respectively, and each of the reference optical sensing pixels has a respective reference shifting vector. In the present exemplary embodiment, the polar angle of the reference axis 310 is, for example, θ₀, and the polar angle of the reference axis 320 is, for example, 90 degree. For a plurality of optical sensing pixels that are not on the reference axes 310 and 320, such as the optical sensing pixel at (x5, y5), which is an interpolation point 322 having an image height r and a polar angle θ. The optical sensing pixels on the reference axes 310 and 320 such as four optical sensing pixels at coordinates (x1, y1), (x2, y2), (x3, y3), and (x4, y4) have reference shifting vectors represented by a shift 1, a shift 2, a shift 3, and a shift 4, respectively. The optical sensing pixels of the coordinates (x1, y1) and (x3, y3) are at the same image height, while the optical sensing pixels of the coordinate (x2, y2) and (x4, y4) are at same image height different from that of the optical sensing pixels of the coordinates (x1, y1) and (x3, y3). Therefore, a shifting vector Shift5 of the optical sensing pixel at (x5, y5) can be interposed according to the reference shifting vectors Shift1, Shift2, Shift 3, and Shift 4, such as by interpolation or extrapolation. For example, first, the shifting vector on the polar angle θ is interpolated, and then the shifting vector Shift5 is obtained by interpolating the shifting vector for the second time according to an image height r. The actual method of the interpolation can be preformed in a selected way without being limited to the above method. A specific example of the interpolation method is illustrated in the following. First, the reference shifting vectors Shift1, Shift2, Shift3, and Shift4 are determined through a simulation according to the predetermined image quality condition. Then, the radial distance of Shift 5, r=((x3−x0)²+(y3−y0)²)^{1/2} is calculated to determine which one of two dotted line areas the shifting vector Shift5 is located in, which, for example, is shown as a dotted line area encompassed by the Shift1 and the Shift2˜Shift4. Second, any angle of a non-simulated point θ=arctan(y5/x5) can be calculated. Therefore, though the relationship between the shifting vector and the angle θ, the shifting vectors Shift2 and Shift4 can be used for interpolation to obtain shift(i)=shift2+((shift4−shift2)/90−θ₀)×(θ−θ₀), and the shifting vectors Shift1 and Shift3 are used for interpolation to obtain shift(j)=shift1+((shift3−shift1)/90−θ₀)×(θ−θ₀). To note that the angle θ₀ is a constant angle, which is for referenced only. Finally, the Shift(i) and Shift(j) at the radial distances of r are used for interpolation to obtain shift5=shift(i)+((r−rᵢ)/(rⱼ−rᵢ)×(shift(j)−shift(i)), wherein rⱼ and rᵢ are the radial distances of Shift(i) and Shift(j), respectively. Furthermore, a shifting vector of X-axis (=shift5*cos θ) and a shifting vector (=shift5*sin θ) of Y-axis for the shifting vector Shift5 can be obtained also.

In summary, after simulating and scanning points for the required incident angles of light, the shifting vectors for the reference optical sensing pixels can be first sifted out based on the image quality condition. Then the final reference shifting vectors can be determined, for example by curve fitting, wherein each of the reference shifting vectors can be further decomposed into a shifting vector in the x direction and a shifting vector in the y direction. In addition, the shifting vector in the x direction and the shifting vector in the y direction of any other optical sensing pixels can be obtained by interpolation according to the relationship of the polar angle and the image height on the optical sensing pixel array. The process is then extended to the entire optical sensing array to completely obtain the shifting vectors for all of the optical sensing pixels.

According to the exemplary embodiment shown in FIG. 4, the reference vectors of the reference optical sensing pixels on the reference axes can be obtained according to the simulation for the actual structure of the pixel array. Next, the shifting vectors of other pixels can be obtained according to the reference shifting vectors. To note that the structures of optical sensing pixels with identical image height (i.e. having the same radial distance) but different polar angles are actually different (such as those shown in FIG. 2). After simulation, two asymmetric shifting vectors can be obtained for two micro-optical device sets with respect to two optical sensing pixels at the same image height but on two polar axes along opposite directions. Regarding the term “asymmetric,” it represents different magnitudes, and/or directions not exactly opposite to each other; in other words, the asymmetric characteristic here represents a relationship without equal magnitudes and/or opposite directions. For example, in comparison of the reference axis 1 and reference axis 3, the two shifting vectors at the same image height are asymmetrical. Based on the same reason, for example, two shifting vectors at the same image height on the reference axis 6 and reference axis 8 are also asymmetrical.

FIG. 12 is a diagram illustrating the mechanism of the asymmetric shifting vector according to an exemplary embodiment of the present invention. Referring to FIG. 12, which has a configuration similar to that shown in FIG. 6, in the optical sensing pixel array 100, the reference origin 90 is a starting point of polar axes. For two optical sensing pixels that are located on two polar axes along opposite directions, for example, a polar axis 300a and a polar axis 300b respectively, or a polar axis 302a and a polar axis 302b respectively, and at the same image height (corresponding to 60% of full image height, shown by a circle for example), the two micro-optical device sets thereof have two shifting vectors that are asymmetric. On the other hand, for other optical sensing pixels not located on the reference axes, the shifting vectors are obtained through interpolation, and they also have the characteristic of asymmetry as described above.

In summary, at least based on the reasons mentioned above, the exemplary embodiments of the present invention perform practical simulation for the desired corresponding incident angle according to the actual structure of the optical sensing pixel to obtain simulated reference shifting vectors. As shown in FIG. 6 and FIG. 12, the reference shifting vectors with respect to a pair of the optical sensing pixels opposite to each other are asymmetric, and the shifting vectors obtained after the interpolation are also asymmetric.

It should be also noted that the individual shifting vectors of the micro-optical device sets of the optical sensing pixels in the same array element can be all same or be different, with respect to the shifting vector of optical sensing pixel. For the different optical sensing pixels in the same array element, the shifting vectors of the optical sensing pixels are obtained by adding sub-shifting vectors to a common main shifting vector, respectively, for example. And the shifting vector of the sub-shifting vectors may be equal (e.g. all of the sub-shifting vectors equal to zero) or unequal. The fine-tuning between the optical sensing pixels of the array element in an example can reduce the color shading or crosstalk that occurs due to different focal distances for different wavelengths.

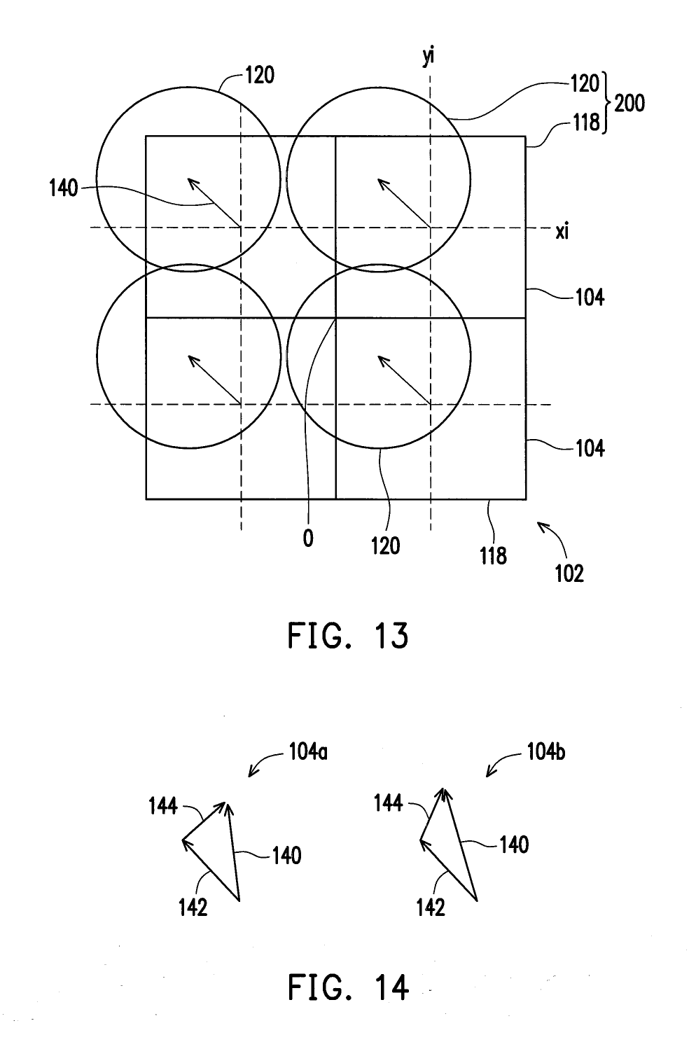

FIG. 13 is a diagram illustrating the shifts of the micro-optical device sets according to an exemplary embodiment of the present invention. Referring to FIG. 13, the micro-optical device set of present exemplary embodiment on each of the optical sensing pixels of a same array element 102 is identical. For example, an array element 102 may be composed of one or multiple optical sensing pixels (e.g. 4 optical sensing pixels), each for sensing the desired color component respectively according to the color of the color filter device. A radial vector r denotes a vector of the array element 102 with respect to a reference origin O. For each of the optical sensing pixels 104, the micro-optical device set may include a color filter device 118 and a micro-lens 120. Both the color filter device 118 and the micro-lens 120 may be shifted simultaneously or merely one of them is shifted, or both have different shifts. In the present exemplary embodiment, the micro-lens 120 has a shift while the color filter device 118 does not have shift. The shifting vectors 140 of all of the micro-lenses 120 with respect to the central point of the corresponding optical sensing pixel 104 are the same.

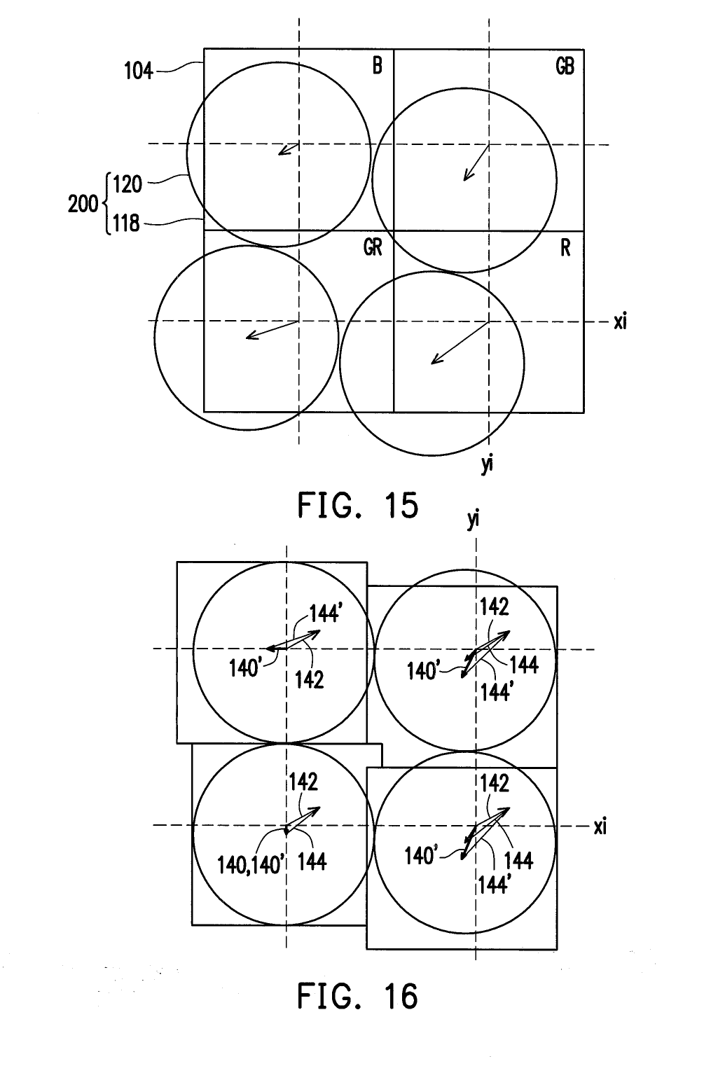

FIG. 14 is a diagram illustrating the shifts of the micro-optical device sets according to an exemplary embodiment of the present invention. Referring to FIG. 14, the shifting vectors of the present embodiment for the plurality of optical sensing pixels of the array element 102 are not required to be the same. For one of the optical sensing pixel 104a, the shifting vector 140 may be determined by adding a sub-shifting vector 144 to a main shifting vector 142. For determining the reference vector by simulation, the simulation can be performed directly for each of the optical sensing pixels. Alternatively, an initial simulation may be performed by using the array element as a unit according to the mechanism adapted by the simulation. The result of the initial simulation can be served as the main shifting vector. If the differences between each of the optical sensing pixels in the array element are not required to be considered, the main shifting vector can be used directly as the desired shifting vector.

However, if the differences between each of the optical sensing pixels in the array element are considered, the main shifting vector can be further fine-tuned with the sub-shifting vector 144. In other words, for another optical sensing pixel 104b, each of the micro-optical device sets 200 can be shifted by a different shifting vector 140, which can be obtained by adding a different sub-shifting vector 144 to the same main shifting vector 142. Similarly, both the color filter device 118 and the micro-lens 120 can be shifted simultaneously or merely one of them is shifted, according to the shifting vector 144 or different shifts, respectively.

FIG. 15 is a diagram illustrating the shifts of the micro-optical device sets according to an exemplary embodiment of the present invention. The internal coordinates of each optical sensing pixel are depicted by xᵢ axis and yᵢ axis, with the intersection points being the predetermined positions of the optical sensing pixels. An array element is, for example, composed by four optical sensing pixels such as a blue B, a red R, a green-blue GB, and a green-red GR which is generally called the Bayer pattern. In the present embodiment, for example, the micro-lens of the micro-optical device sets 200 with respect to the optical sensing pixels have different shifting vectors, and the color filter devices 118 do not have shifts or do have identical shifts. However, devices with shifts in the micro-optical device sets 200 are not limited to those shown in the present embodiment.

FIG. 16 is a diagram illustrating the shifts of the micro-optical device sets according to an exemplary embodiment of the present invention. Referring to FIG. 16, for example, both the color filter device 118 and the micro-lens 120 of the micro-optical device sets 200 have shifts. An arrow 142 represents a main shifting vector 142, which is common for use. An arrow 144 represents a sub-shifting vector 144 for one of the components in the micro-optical device sets 200, such as the micro-lens 120, and an arrow 140 is obtained by adding all vectors to represent the desired shifting vector 140. Furthermore, a bolded arrow 140′ represents a shifting vector 140′ obtained by adding a sub-shifting vector 144′ of the color filter device 118 to the main shifting vector 142, wherein the color filter device 118 is another component within the micro-optical device sets 200. However, components having shifts within the micro-optical device sets 200 are not limited to those shown in the present embodiment.

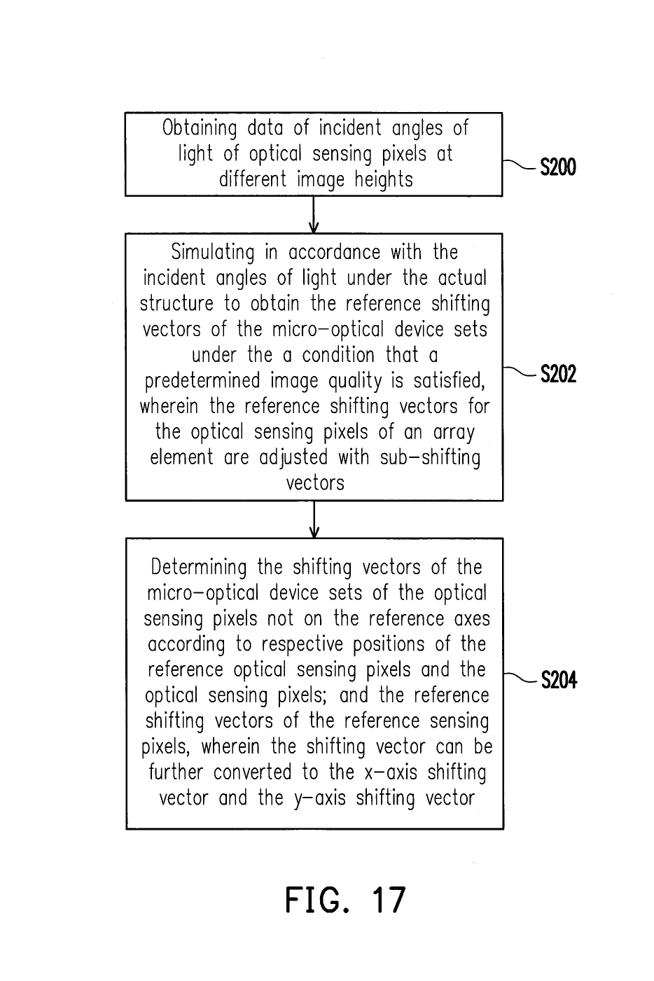

FIG. 17 is a flow chart illustrating the optical setting method according to an exemplary embodiment of the present invention. Referring to FIG. 17, in step S200, data of incident angles of light of the optical sensing pixels at the different image heights are obtained. In step S202, under the actual structure, simulating the incident angles of light obtained in step S200 to obtain the reference shifting vectors of the micro-optical device sets while the predetermined image quality condition is satisfied, wherein the reference shifting vectors for the optical sensing pixels of an array element are adjusted with the sub-shifting vectors. In step S204, the shifting vectors of the micro-optical device sets of the optical sensing pixels not on the reference axes are determined according to respective positions of the reference optical sensing pixels and the optical sensing pixels; and the reference shifting vectors of the reference sensing pixels, wherein the step can also include a converting process to convert the shifting vector to the x-axis shifting vector and y-axis shifting vector.

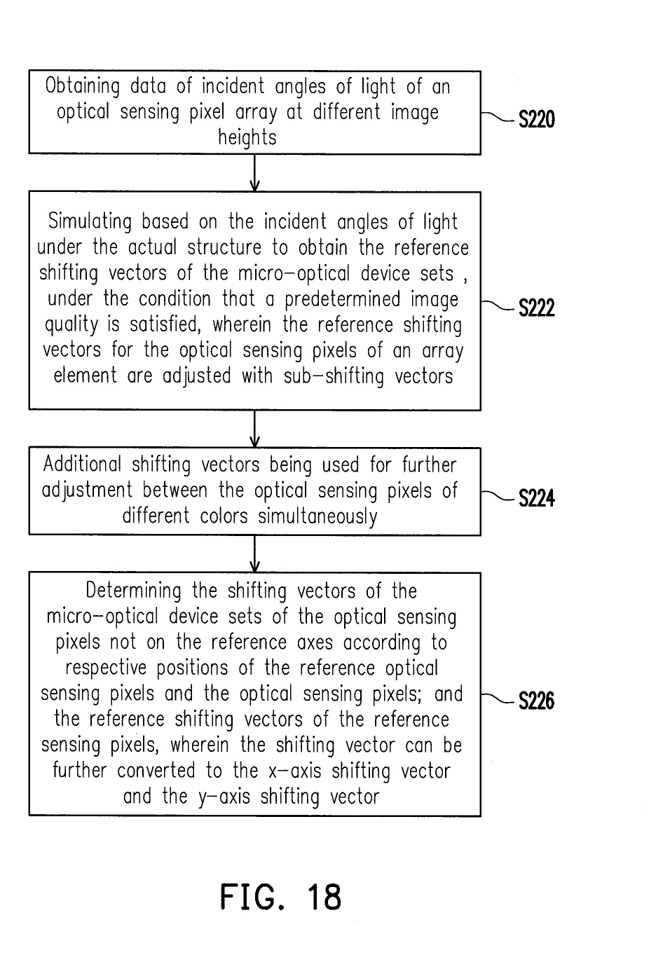

FIG. 18 is flow chart illustrating the optical setting method according to an exemplary embodiment of the present invention. Refer to FIG. 18, and consider the adjustment of the optical sensing pixels of different colors at the same time. In step S220, data of the incident angles of light of optical sensing pixel array at different image heights is obtained. In step S222, under the actual structure, based on the incident angles of light obtained in step S220, a simulation is performed to obtain the reference shifting vectors of the micro-optical device sets under the condition that the predetermined image quality is satisfied, wherein the reference shifting vectors between the optical sensing pixels of an array element are adjusted with the sub-shifting vectors. In step S224, additional shifting vectors are used for further adjustment between the optical sensing pixels of different colors simultaneously. In step S226, the shifting vectors of the micro-optical device sets of the optical sensing pixels that are not on the reference axes are determined, according to respective positions of the reference optical sensing pixels and the optical sensing pixels; and the reference shifting vectors of the reference sensing pixels. Step S226 can further include a converting process to convert the shifting vector to the x-axis shifting vector and y-axis shifting vector.

In summary, the reference shifting vectors of the reference optical sensing pixels in the embodiments are determined by simulating the actual pixel structure of the optical sensing pixels, which at least includes the factor of the asymmetrical structures of the metal routings in the pixels. Therefore, on two polar axes along opposite directions, the two shifting vectors are asymmetric between two micro-optical device sets for two optical sensing pixels at the same image height.

Although the present invention has been described with reference to the above embodiments, however, the present invention is not limited thereto. It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. An optical sensing apparatus, comprising:
an optical sensing pixel array, having a plurality of array elements, each of the array elements having one or multiple of a plurality of optical sensing pixels; and
a plurality of micro-optical device sets, configured corresponding to the optical sensing pixels respectively, each of the micro-optical device sets having a shifting vector with respect to corresponding one of the optical sensing pixels,
wherein the optical sensing pixel array has a reference original point, and two shifting vectors of two of the micro-optical device sets with respect to corresponding two of the optical sensing pixels at a same radial distance on two polar axes from the reference origin point and along opposite directions are asymmetric.

2. The optical sensing apparatus as claimed in claim 1, further comprising at least a first reference axis from the reference original point at a first polar angle and a second reference axis from the reference original point at a second polar angle, wherein the optical sensing pixels belonging to the first reference axis and the second reference axis are a plurality of reference optical sensing pixels,
wherein the shifting vectors of the micro-optical device sets corresponding to the reference optical sensing pixels are a plurality of reference shifting vectors, and the shifting vectors of the micro-optical device sets not corresponding to the reference optical sensing pixels are determined according to the reference shifting vectors of the reference optical sensing pixels and respective positions of the optical sensing pixels.

3. The optical sensing apparatus as claimed in claim 2, wherein the reference shifting vectors are determined through simulation under an actual pixel structure.

4. The optical sensing apparatus as claimed in claim 2, wherein each one of the shifting vectors of the micro-optical device sets not corresponding to the reference optical sensing pixels is an interposing value of the adjacent reference shifting vectors.

5. The optical sensing apparatus as claimed in claim 4, wherein the interposing value of each of the optical sensing pixels is obtained by interpolation calculation or extrapolation calculation according to a radial distance of each optical sensing pixel and a polar angle with respect to the first polar angle and the second polar angle.

6. The optical sensing apparatus as claimed in claim 2, wherein the optical sensing pixel array is divided into a plurality of sectional areas based on ranges of polar angles, each of the sectional areas respectively comprises the first reference axis and the second reference axis individually, and
the shifting vectors of the micro-optical device sets not correspond to the reference optical sensing pixels in each of the sectional areas is determined according to the reference shifting vectors of the reference optical sensing pixels on the first reference axis and the second reference axis and respective positions of the optical sensing pixels in each of the sectional areas.

7. The optical sensing apparatus as claimed in claim 6, wherein the first reference axis and the second reference axis of each of the sectional areas are located on borders thereof.

8. The optical sensing apparatus as claimed in claim 6, wherein the polar angles of the first reference axis and the second reference axis in the optical sensing array are at least two angles of 0 degree, 90 degree, 180 degree, 270 degree, and angles to corners of the optical sensing pixel array.

9. The optical sensing apparatus as claimed in claim 1, wherein each of the optical sensing pixels comprises an optical sensing device set and a metal routing structure that is asymmetric with respect to an individual original point of the optical sensing pixel.

10. The optical sensing apparatus as claimed in claim 1, wherein the shifting vectors of the micro-optical device sets with respect to the optical sensing pixels belonging to a same one of the array elements are same.

11. The optical sensing apparatus as claimed in claim 1, wherein the shifting vectors of the micro-optical device sets with respect to the optical sensing pixels belonging to a same one of the array elements are obtained by adding a common shifting vector with respective sub-shifting vectors of the micro-optical device sets.

12. The optical sensing apparatus as claimed in claim 11, wherein the sub-shifting vectors of the micro-optical device sets corresponding to the optical sensing pixels of different colors in a same one of the array elements are different to one another.

13. The optical sensing apparatus as claimed in claim 11, wherein the sub-shifting vectors of the micro-optical device sets corresponding to the optical sensing pixels of different colors in a same one of the array element are all same.

14. The optical sensing apparatus as claimed in claim 1, wherein each of the micro-optical device sets comprises one or multiple micro-optical devices, at least one of the one or multiple micro-optical devices with respect to corresponding one of the optical sensing pixels is shifted according to the shifting vector.

15. The optical sensing apparatus as claimed in claim 14, wherein each of the one or multiple micro-optical devices is a micro-lens, a color filter device, or a diffraction device.

16. The optical sensing apparatus as claimed in claim 14, wherein at least one of the micro-optical devices in each of the micro-optical device sets has no shift with respect to the corresponding one of the optical sensing pixels.

17. The optical sensing apparatus as claimed in claim 1, wherein each of the micro-optical device sets comprises a micro-lens and a color filter device, the micro-lens with respect to corresponding one of the optical sensing pixels has the shifting vector, the color filter device further has an additional shifting vector in addition to the shifting vector.

18. The optical sensing apparatus as claimed in claim 1, wherein each of the micro-optical device sets comprises a diffraction device and a color filter device, the diffraction device with respect to the corresponding one of the optical sensing pixels has the shifting vector, the color filter device further has an additional shifting vector in addition to the shifting vector.

19. An optical setting method, used for an optical sensing pixel array, wherein the optical sensing pixel array is composed of a plurality of array elements, each of the array elements has one or multiple of a plurality of optical sensing pixels; and a plurality of micro-optical device sets are respectively configured corresponding to the optical sensing pixels, the optical setting method comprising:
setting a shifting vector for each of the micro-optical device sets with respect to corresponding one of the optical sensing pixels, wherein setting two shifting vectors being asymmetric for two of the micro-optical device sets with respect to corresponding two of the optical sensing pixels at a same radial distance on two polar axes starting from a reference original point of the optical sensing pixel array and along opposite directions.

20. The optical setting method as claimed in claim 19, wherein setting of the shifting vector comprising:
setting a first reference axis from the reference original point at a first polar angle and a second reference axis from the reference original point at a second polar angle, wherein the optical sensing pixels belonging to the first reference axis and the second reference axis are a plurality of reference optical sensing pixels;
setting the shifting vectors corresponding to the micro-optical device sets with respect to the reference optical sensing pixels to be a plurality of reference shifting vectors; and
determining the shifting vectors of the micro-optical device sets not correspond to the reference optical sensing pixels according to the reference shifting vectors of the reference optical sensing pixels and respective positions of the optical sensing pixels.

21. The optical setting method as claimed in claim 20, wherein determining the reference shifting vectors is determined by simulating under an actual pixel structure.

22. The optical setting method as claimed in claim 20, wherein setting an interposing value of each of the shifting vectors of the micro-optical device sets not of the reference optical sensing pixels, according to the reference shifting vectors.

23. The optical setting method as claimed in claim 22, wherein the interposing value of each of the optical sensing pixels is obtained by interpolation or extrapolation calculations according to a respective radial distance of each optical sensing pixel and a polar angle with respect to the first polar angle and the second polar angle.

24. The optical setting method as claimed in claim 20, further
dividing the optical sensing pixel array into a plurality of sectional areas based on ranges of polar angles, wherein each of the sectional areas comprises the first reference axis and the second reference axis individually, and
determining the shifting vectors of the micro-optical device sets of the optical sensing pixels other than the reference optical sensing pixels in each one of the sectional areas according to the reference shifting vectors of the reference optical sensing pixels on the first reference axis and the second reference axis and respective positions of the optical sensing pixels in each of the sectional areas.

25. The optical setting method as claimed in claim 24, wherein the first reference axis and the second reference axis of each of the sectional areas are located on borders thereof.

26. The optical setting method as claimed in claim 24, wherein the polar angles of the first reference axis and the second reference axis in the optical sensing array are at least two degrees at 0 degree, 90 degree, 180 degree, 270 degree, and angles to corners of the optical sensing array.

27. The optical setting method as claimed in claim 19, wherein each of the optical sensing pixels comprises an optical sensing device set and a metal routing structure that is asymmetric with respect to an individual original point of the optical sensing pixel.

28. The optical setting method as claimed in claim 19, wherein the shifting vectors of the micro-optical device sets with respect to the optical sensing pixels belonging to the same array element are same.

29. The optical setting method as claimed in claim 19, wherein the shifting vectors of the micro-optical device sets with respect to the optical sensing pixel belonging to a same one of the array elements are obtained by adding a common shifting vector with respective sub-shifting vectors of the micro-optical device sets.

30. The optical setting method as claimed in claim 29, wherein the sub-shifting vectors of the micro-optical device sets corresponding to the optical sensing pixels of different colors in a same one of the array elements are different to one another.

31. The optical setting method as claimed in claim 29, wherein the sub-shifting vectors of the micro-optical device sets corresponding to the optical sensing pixels of different colors in a same one of the array elements are all same.

32. The optical setting method as claimed in claim 19, wherein each of the micro-optical device sets comprises one or multiple micro-optical devices, at least one of the one or multiple micro-optical devices with respect to the optical sensing pixel is shifted according to the shifting vector.

33. The optical setting method as claimed in claim 19, wherein each of the one or multiple micro-optical devices is a micro-lens, a color filter device, or a diffraction device.

34. The optical setting method as claimed in claim 32, wherein at least one of the micro-optical devices in each of the micro-optical device sets has no shift with respect to the corresponding one of the optical sensing pixels.

35. The optical setting method as claimed in claim 19, wherein each of the micro-optical device sets comprises a micro-lens and a color filter device, the micro-lens with respect to corresponding one of the optical sensing pixels has the shifting vector, the color filter device further has an additional shifting vector in addition to the shift vector.

36. The optical setting method as claimed in claim 19, wherein each of the micro-optical device sets comprises a diffraction device and a color filter device, the diffraction device with respect to corresponding one of the optical sensing pixels has the shifting vector, the color filter device further has an additional shifting vector in addition to the shifting vector.

37. An optical setting method, comprising:
obtaining data of incident angles of light onto an optical sensing pixel array at different radial distances;
obtaining a plurality of reference shifting vectors of a plurality of micro-optical device sets corresponding to a plurality of reference optical sensing pixels in the optical sensing pixel array under a condition that a predetermined image quality is satisfied, according to the data of the incident angles of light and an actual structure of the optical sensing pixel array; and
obtaining a plurality of shifting vectors of the micro-optical sets for the other optical sensing pixels in the optical sensing pixel array other than the reference optical sensing pixels according to respective positions of the other optical sensing pixels and positions of the reference optical sensing pixels, and the reference shifting vectors.

38. The optical setting method as claimed in claim 37, starting from a reference original point of the optical sensing pixel array, setting two shifting vectors being asymmetric for two of the micro-optical device sets with respect to corresponding two of the optical sensing pixels at a same radial distance on two polar axes along opposite directions.
